(19) United States
(12) Patent Application Publication
(10) Pub. No.: US 2005/0126329 A1
(43) Pub. Date: Jun. 16, 2005

(54) SHIFTER FOR A BICYCLE TRANSMISSION

(75) Inventor: Georg Blaschke, Geldersheim (DE)

Correspondence Address: SRAM CORPORATION, 1333 N. KINGSBURY, 4TH FLOOR, CHICAGO, IL, 60622, US

(73) Assignee: SRAM DEUTSCHLAND GMBH, Schweinfurt (DE)

(21) Appl. No.: 10/904,798

(22) Filed: Nov. 30, 2004

(30) Foreign Application Priority Data
Dec. 12, 2003 (DE) 10358438.2

(51) Int. Cl. G05G 5/06

(52) U.S. Cl. 74/501.6

(57) ABSTRACT

A shifter for a bicycle transmission that includes a housing, a cable spool, an actuator, a locking pawl simultaneously engageable with teeth of a releasing element and a retaining element. A cable-release operation is initiated by motion of the releasing element relative to the retaining element which causes the releasing teeth to slide under the locking pawl and lift the locking pawl over a retaining tooth. A preload spring is arranged between the actuator and the cable spool to prevent play between the actuator and the cable spool and is also preloaded during the cable-release operation to assist the cable-release operation after the locking pawl is released from the retaining teeth.

The present invention relates to bicycle shifters and more particularly to a bicycle shifter that includes a locking pawl that simultaneously engages a retaining contour and a releasing contour.

Bicycle shifters are used to pull and release a tensioned control cable connected to a gear change mechanism and to hold the desired gear ratio. These types of shifters are disclosed in the German patent applications DE 1 99 18 520 A1 and DE 1 033 063. These shifters generally include an actuator and a cable spool for pulling and releasing cable and a retaining device for holding the tensioned control cable in a particular position. The actuator rotates the cable spool, while the retaining device continuously holds the cable spool in a current shift position and thus counteracts the return force of the tensioned control cable.

DE 1 99 18 520 A1 discloses a shifter including a rotatable actuator nonrotatably connected to the cable spool having a locking pawl that engages retaining teeth on the housing and holds a current shift position or gear ratio. A releasing element on the actuator is provided to cancel the holding action of the locking pawl to release the control cable or shifting cable. Once the holding action of the locking pawl is cancelled, the cable spool rotates in a release direction, under the force of an additional spring element and the tension in the shifting cable, until the locking pawl once again engages a retaining tooth. To pull the shifting cable, the actuator is rotated in the opposite direction so that the cable spool and the locking pawl are rotated by a drive element. When the actuator is released, the locking pawl ratchets against the next retaining tooth and the cable spool may rotate slightly in the cable-release direction.

The shifter disclosed in DE 1 033 063 includes a cable spool having retaining teeth, and an actuator that always returns to its starting position after an operation. During a cable-pull operation, the actuator engages a stop on the cable spool causing the locking pawl to ratchet over the retaining teeth on the cable spool. After completion of the shifting operation, the actuator returns back to its starting position, while the locking pawl holds the current shift position by engaging the retaining teeth. The release operation is initiated by pivoting the actuator in the release direction. The locking pawl is moved by the actuator out of the retaining teeth, and after a defined pivoting motion, the locking pawl comes into contact against the next retaining tooth to hold the current shift position. The retaining teeth are located on different radii relative to the rotation point of the cable spool.

The shifters disclosed in the above-mentioned patent applications are functional but are sluggish, sensitive to tolerances and demanding in terms of manufacture and space requirements. Further, the shifters produce loud shifting noises. Therefore, there is a need for a shifter that is uncomplicated and has a single-axis configuration.

### SUMMARY OF THE INVENTION

An object of the present invention is to provide a shifter having shifting components that can be economically manufactured and are both suitable for both lever shifters and twistshifters.

The present invention provides a shifter for a bicycle transmission. The shifter generally includes a housing, an actuator, a cable spool, a locking pawl and retaining and releasing elements. The housing is mounted to a handlebar. The actuator is operated by the rider to select a desired gear ratio. The actuator is connected to the housing via a mandrel. The cable spool includes a tab that rotatably connects the cable spool to the actuator. The releasing element is nonrotatably connected to the actuator and the retaining element is nonrotatably connected to the cable spool. The releasing element includes a releasing contour having a plurality of releasing teeth. The retaining element includes a retaining contour having a plurality of retaining teeth. The locking pawl holds the desired gear ratio. The locking pawl has first and second ends. The first end of the locking pawl is supported in the housing. The second end of the locking pawl simultaneously engages the retaining and releasing contours and may be biased toward the retaining element. In one embodiment of the present invention, the locking pawl is a spring supported by the housing near the cable guide for the control cable. This configuration minimizes the outer diameter of the housing which is especially favorable for twistshifters.

The retaining element may be a disk having a retaining contour on its periphery. Alternatively, the retaining element and the cable spool may form one part. The releasing element may also be a disk having a releasing contour on its periphery. Alternatively, the releasing element and the actuator may form one part. The elevations of the retaining contours form retaining teeth having retaining edges and the elevations of the releasing contour form releasing teeth having saw-tooth shapes. Each retaining tooth corresponds to a releasing tooth. The spacing between the retaining teeth corresponds to a gear ratio and the necessary control cable displacement for each gear change. The configuration of the releasing teeth, in particular the tooth flank facing in the releasing direction, provides a desired releasing profile that substantially influences shifting sensitivity. The releasing profile of the tooth flank of the releasing teeth can have a straight, convex, concave or any other type profile sufficient to move the locking pawl out of locked engagement with the retaining tooth. In addition to the simple and compact construction, the present invention provides an individual release travel and release force for each gear ratio because of the various shapes of the releasing teeth.

In one embodiment, the locking pawl is a spring supported by the housing near a control cable guide. The locking pawl may be biased toward the retaining and releasing elements to provide a rapid and reliable retaining function. A first end of the spring is supported by the housing and a second end of the spring is engageable with the retaining and releasing teeth. The contours of the retaining and releasing teeth have opposite facing profiles relative to each other. The retaining teeth have a steep retaining edge that functions as a stop for the locking pawl and the releasing teeth have a releasing profile. During the cable-release operation, the releasing element rotates relative to the retaining element causing the releasing profile of the releasing tooth to slide under the locking pawl and move it out of its locked state on the retaining tooth. A shifting sensitivity and releasing behavior dependent on gear ratio can be achieved by the association of the releasing teeth with the corresponding retaining teeth.

In another embodiment, a preload spring is arranged between the actuator and the cable spool to assist the release operation and to prevent any play between the actuator and the cable spool. The preload spring may be a compression spring received in a slot in one of the cable spool and the actuator. One end of the preload spring is braced against an end of the slot and another end of the preload spring is braced against a tab that extends from one of the actuator and cable spool. Another end of the slot also serves a stop for the tab that the preload spring acts on.

As the locking pawl is being pushed out of engagement with the retaining tooth by the releasing tooth during a release operation, the preload spring is being preloaded by the tab on the actuator because of the relative motion between the releasing element and the retaining element. As the locking pawl travels over the retaining tooth, the retaining element or the cable spool is then released and the preload spring once again presses the tab against the end of the slot. The preload spring provides a shifting force in the release direction that is built up before the locking pawl has ratcheted out. Depending on the spring preload and the spring characteristic curve, this shifting force influences the shifting behavior and shifting sensitivity of the shifter.

During the cable-pull operation, the rotational movement of the actuator or rotatable grip is transferred directly to the cable spool via at least one drive element extending from the actuator to the cable spool. The locking pawl slides over the retaining teeth and the corresponding releasing tooth. At the end of the cable-pull operation, the locking pawl ratchets into the next tooth gap of the retaining contour and braces itself once again against the corresponding retaining edge of the next retaining tooth. The cable spool or tensioned control cable thus travels a defined shifting distance. If the actuator is moved further, it is thus also possible to shift through several gears in succession with one actuation, the ratcheting of the locking pawl into place indicating that a new gear ratio has been reached.

The shifting operation in the cable-release direction can be effected either by way of two mutually independent actuators or with a single actuator. With two actuators, each actuator can be optimally designed in terms of ergonomics and shifting force. As a general rule, a longer lever arm or lever travel will be chosen for the cable-pull operation than for the release operation, which involves merely moving the locking pawl out of locked engagement with the retaining contour. The device having one actuator for the cable pull and release operations, on the other hand, is particularly suitable for a twistshifter that is rotatable in two directions.

The prevent invention allows its components, in particular the cable spool, retaining element, releasing element and the actuator, to be arranged around a central axis. This configuration permits a very compact design that is suitable for both lever shifters and twistshifters.

These and other features and advantages of the present invention will be more fully understood from the following description of certain embodiments of the invention, taken together with the accompanying drawings.

### BRIEF DESCRIPTION OF THE DRAWINGS

In the drawings:

FIG. 1 is an exploded view of a shifter in accordance with one embodiment of the present invention;

FIG. 2 is an exploded view of the shifter showing, in particular, the control cable guide;

FIG. 3 is an exploded view of the shifting showing a preload spring in the actuator; and

FIGS. 4a-4c are front views of retaining and releasing elements of FIGS. 1 and 2 showing various positions of the retaining and releasing elements during a release operation of the shifter.

### DETAILED DESCRIPTION

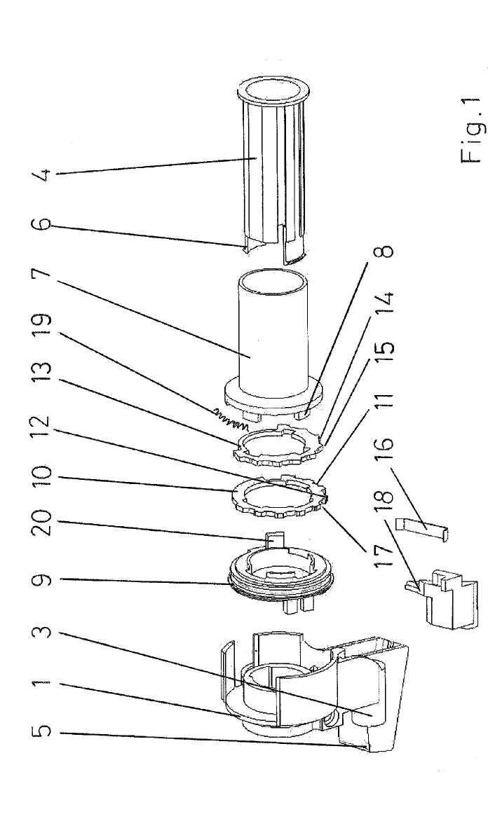

FIGS. 1-4 illustrate a bicycle shifter in accordance with one embodiment of the present invention. The shifter generally includes a housing 1, an actuator 7, a retaining element 12, a releasing element 13, a locking pawl 16 and a cable spool 9. Looking to FIG. 1, the housing 1 includes an integrated handlebar clamp 2, a cable guide portion 3 for receiving a control cable (not shown) and a brake housing portion 5. The actuator 7 is mounted over a mandrel 4 that includes two elastic retaining fingers 6 that snap into the housing 1. The actuator 7 is rotatable in a cable-pull direction and a cable-release direction opposite the cable-pull direction. The actuator 7 includes at least one drive element 8 engageable with the cable spool 9 to transfer the shifting motion in the cable-pull direction to the cable spool. Alternatively, the drive element 8 may be located on the cable spool 9. The retaining element 10 is nonrotatably connected to the cable spool 9 and includes a retaining contour 11 having a plurality of retaining teeth 12. The releasing element 13 is nonrotatably connected to the actuator 7 and includes a releasing contour 14 having a plurality of releasing teeth 15. The retaining and releasing elements 10, 13 are arranged relative to each other such that the releasing teeth 15 correspond to the retaining teeth 12. The locking pawl 16 is supported by the housing 1. A first end of the locking pawl 16, in this embodiment a spring, is supported by an insert 18 received in the housing 1 and a second end of the locking pawl 16 simultaneously engages the retaining and releasing contours 11, 14.

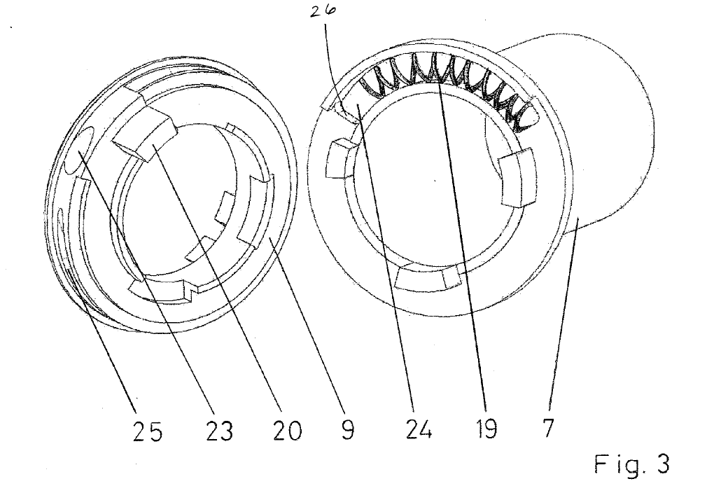

During a cable-pull operation, the locking pawl 16 slides over the retaining tooth 12 and the adjacent releasing tooth 15 and ratchets into the next tooth gap. The locking pawl 16 braces against a retaining edge 17 of the retaining to prevent the cable spool 9 from rotating back after the cable-pull operation. During a cable-release operation, the releasing element 13 is rotated with the actuator 7 in the release direction causing the releasing tooth 15 to move the locking pawl 16 over the retaining edge 17 of the retaining tooth 12. As a result, the cable spool 9 and the retaining element 10 rotate under the tension force of the control cable, in the release direction, until the locking pawl 16 engages the next retaining edge 17, terminating the release operation. The amount of releasing motion initiated by the control cable differs for each gear ratio because the control cable displacement for each gear ratio is different. Thus, a preload spring 19 that biases the cable spool 9 and the actuator 7 proves to be very advantageous here. The preload spring 19, in this embodiment a compression spring, is arranged on the actuator 7 and has a first end braced against the actuator 7 and a second end biases a tab 20 on the cable spool against a stop 26 on the actuator 7, see FIG. 3. This configuration eliminates any play between the actuator 7 and the cable spool 9. The preload spring 19 is biased by the tab 20 during the release operation or during relative motion between the retaining and releasing elements 10, 13 and is not released until the releasing tooth 15 has moved the locking pawl 16 out of its current position over the retaining edge 17 of the retaining tooth 12. As the preload spring 19 relaxes, the tab 20 is pushed back against the stop 26 of the actuator 7, resulting in the cable spool 9 being accelerated in the release direction. The preload spring 19 ensures a rapid shifting motion, independent of the gear ratio, in the release direction.

The present invention provides a simple and space-saving configuration that is arranged about a central axis. This configuration is particularly suitable for twistshifters. The sophisticated and efficient arrangement of the retaining and releasing elements 10, 13 and the simultaneous engagement of the locking pawl 16 with the retaining and releasing contours 11, 14 are, however, also suitable for lever shifters. For example, the actuator 7 may be replaced with first and second actuating elements such as two levers, a cable-pull lever and a cable-release lever. The retaining element 10 is connected to or moved with the cable-pull lever and the cable-release lever is connected or moved with the releasing element 13.

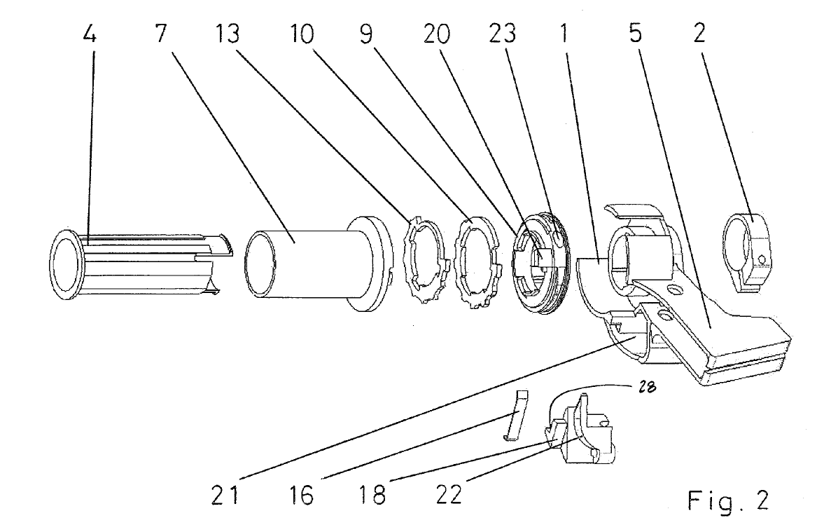

Looking to FIG. 2, the housing 1 is attached to the handlebar with handlebar clamp 2. The brake housing portion 5 has holes for a brake lever pivot and a recess 21 for receiving the insert 18. The insert 18 includes a receptacle 28 for the locking pawl 16 and a control cable guide. The rotationally movable parts of the shifter include the cable spool 9, retaining element 10, releasing element 13, and the actuator 7. These elements are mounted on the mandrel 4 that is secured to the housing 1 by the retaining fingers 6. The tab 20 nonrotatably connects the retaining element 10 to the cable spool 9. The cable spool 9 includes a cable groove 25 and a bore 23 for receiving an end of the control cable to secure the control cable to the cable spool 9, see FIG. 3.

Looking to FIG. 3, the preload spring 19 is disposed in a slot 24 extending radially on the actuator 7. In the assembled state, the tab 20 is received in the slot 24. One end of the preload spring 19 is braced against the tab 20 and another end of the preload spring 19 is braced against one end of the slot 24. Another end of the slot 24 is the stop 26 for the tab 20 that defines a relationship between the actuator 7 and the cable spool 9. During a cable-pull operation, the cable spool 9 is rotated by the actuator 7 via the tab 20. During a cable-release operation, the cable spool 9 is rotated only after the locking pawl 16 is disengaged. Disengagement of the locking pawl 16 is accomplished by relative motion between the retaining and releasing elements 10, 13. This relative motion results from the relaxation of the preload spring 19, or its preloading by the tab 20. After disengagement of the locking pawl 16, the preload spring 19 delivers this stored energy back to the cable spool 9, thereby accelerating the cable spool and the release operation.

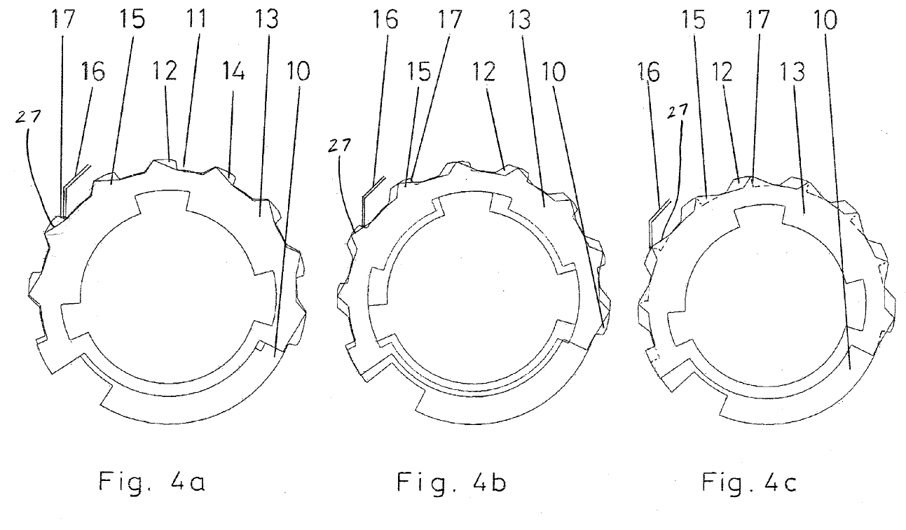

FIGS. 4a-4c show three positions of the retaining and releasing elements 10, 13 during the cable release operation. Looking to FIG. 4a, the retaining and releasing element 10, 13 are in a neutral position before a shifting operation begins. The locking pawl 16 has a width sufficient to simultaneously engage the retaining and releasing contour 11, 14 and engage the retaining edge 17 of the retaining teeth 12. The releasing tooth 15 has, in the releasing direction, a releasing profile 27, in this embodiment a saw-tooth shape, that slides under the locking pawl 16 and moves the locking pawl 16 over to the next retaining tooth 12 during a cable-release operation.

FIG. 4b shows the retaining and the releasing element 10, 13 during a cable-release operation. The releasing element 13 is rotated in the cable-release direction relative to the retaining element 10. The releasing profile 27 of the releasing tooth 15 has already lifted the locking pawl 16, against its spring tension, out of the neutral position to approximately the middle of the retaining edge 17 on the retaining tooth 12.

FIG. 4c shows the releasing element in the release position. The locking pawl 16 has been displaced along the releasing profile 27 on the releasing tooth 15 and outward along the retaining edge 17 on the retaining tooth 12. The locking action of the locking pawl 16 is thus cancelled. The retaining element 10 and the cable spool 9 are rotated by the tensioned control cable and the preload spring 19 in the cable release direction until the locking pawl 16 penetrates the next tooth gap and engages the retaining edge 17 of the next retaining tooth 12. The spacing from one retaining edge 17 to the next need not always be the same; it corresponds to the control cable displacement needed for a gear change. Each retaining tooth to be shifted over has a corresponding releasing tooth associated with it. The contour of the releasing tooth, and their spacings from one another, can thus be coordinated with the respective gear ratio.

Shifting sensitivity is a factor that influences a decision to purchase or not to purchase a certain shifter. This shifting sensitivity is influenced by the coordination among the moving shifter components. This includes not only the coordination of the preload spring and the locking pawl spring, but also the profiles of the tooth flanks of the releasing teeth 15, which in FIGS. 4a-4c exhibit a saw-tooth shape. Concave and convex (or other) contours of this tooth flank may, of course, also prove advantageous in order to achieve a desired shifting sensitivity.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

1. A shifter for a bicycle transmission, comprising:
a housing;
a cable spool for winding a control cable thereon;
an actuator operable to perform a cable-pull operation and a cable-release operation;
a retaining element nonrotatably connected to the cable spool, the retaining element having a retaining contour;
a releasing element nonrotatably connected to the actuator, the releasing element having a releasing contour; and
a locking pawl having first and second ends, the first end supported by the housing, the second end simultaneously engageable with the retaining contour and the releasing contour.

2. The shifter as defined in claim 1, wherein the retaining contour includes a plurality of teeth and the releasing contour includes a plurality of teeth corresponding to the retaining teeth.

3. The shifter as defined in claim 2, wherein the retaining and releasing teeth are configured to provide different amounts of control cable displacement corresponding to each gear change.

4. The shifter as defined in claim 2, wherein the releasing element is configured to move the locking pawl out of locked engagement with a retaining tooth on the retaining element during the cable-release operation.

5. The shifter as defined in claim 4, wherein the actuator is rotatable in a cable-pull direction and a cable-release direction opposite the cable-pull direction, the releasing teeth having a releasing profile in the cable-release direction.

6. The shifter as defined in claim 1, wherein the first end of the locking pawl is supported by the housing near a control cable guide of the housing.

7. The shifter as defined in claim 6, wherein the housing includes a receptacle for receiving the first end of the locking pawl.

8. The shifter as defined in claim 6, wherein the locking pawl is a spring.

9. The shifter as defined in claim 7, wherein the locking pawl is biased to engage the retaining and releasing contours.

10. The shifter as defined in claim 1, wherein a preload spring is arranged between the actuator and the cable spool.

11. The shifter as defined in claim 10, wherein the preload spring is preloaded during the cable-release operation.

12. The shifter as defined in claim 9, wherein the preload spring is preloaded between the actuator and the cable spool.

13. The shifter as defined in claim 11, wherein the preload spring is configured to assist the cable-release operation after the release of one of the cable spool and the retaining element.

14. The shifter as defined in claim 5, wherein the actuator, the retaining element, releasing element and the cable spool have a common rotation axis.

15. The shifter as defined in claim 1, wherein the retaining element and the cable spool are formed as one part.

16. The shifter as defined in claim 16, wherein the actuator and the releasing element are formed as one part.

17. The shifter as defined in claim 1, wherein the actuator includes a first actuating element operable to perform the cable-pull operation and a second actuating element operable to release the locking pawl.

18. The shifter as defined in claim 1, wherein the housing includes a brake housing segment.

19. The shifter as defined in claim 19, wherein the brake housing segment and the housing form one part.
